(19) United States
(12) Patent Application Publication
(10) Pub. No.: US 2004/0209658 A1
(43) Pub. Date: Oct. 21, 2004

(54) Wireless Mobile Phone Headset Capable of Triggering Mobile Phone For Signaling Location and Corresponding Methods

(76) Inventors: Chuan-Wei Liu, Taipei Hsien (TW); Chien-Yi Shih, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,454

(22) Filed: Apr. 11, 2003

(30) Foreign Application Priority Data
Feb. 21, 2003 (TW) 092103724

(51) Int. Cl. H04M 1/00; H04B 1/38

(52) U.S. Cl. 455/575.2; 455/70; 455/569.1

(57) ABSTRACT

A wireless headset for triggering a mobile phone in a mobile phone system to signal a location of the mobile phone and corresponding methods. A user can access incoming communication of the mobile phone through the wireless headset, and the wireless headset includes a control interface for making the wireless headset transmit a radio control signal to the mobile phone, such that the mobile phone will make predetermined sound or vibration to signal its own location.

### BACKGROUND OF INVENTION

1. Field of the Invention

The invention relates to a wireless headset for applying to a mobile phone system and corresponding methods, and more particularly, to a wireless headset that can transmit a radio control signal under an operation of a user to trigger the mobile phone to make a predetermined signal to signal the location of the mobile phone.

2. Description of the Prior Art

With the increasing popularity of wireless communication network technology, the mobile phone that can access wireless communication information has become one of the most popular personal communication devices in the modern society. It is a tendency that a modern mobile phone has to be small and light for allowing a user to more conveniently carry the mobile phone and communicate wirelessly anytime. However, there are some misgivings for modern mobile phones. For example, a car driver may be distracted from speaking with a mobile phone. In addition, the influence of electromagnetic waves transmitted from the mobile phone to a human body is still a controversial issue. Therefore, the headset suitable for the mobile phone is designed to come with the tide of fashion. A user may still enjoy the use and functionality of communicating with the mobile phone through the headset without touching the mobile phone. Therefore the mobile phone may be positioned away from some important organs of the user, such as the brain, so as to avoid the influence of the electromagnetic waves. Among various kinds of headsets, a wireless headset is the most convenient design for the reason of having no wires needed between the mobile phone and the headset for transmitting signals. So the wireless headset has a high convenience.

Please refer to FIG. 1. FIG. 1 is a function block diagram of the mobile phone 12 and the wireless headset 14 of a mobile phone system 10 according to the prior art. The mobile phone 12 comprises a control circuit 16, a wireless communication module 18, a wireless headset module 20, a speaker 26, a microphone 28, a display panel 24, and an MMI (man machine interface) 22. A plurality of buttons 35 may be set in the MMI 22. A user may push the buttons 35 to input instructions or data, and the control circuit 16 will control the operation of the mobile phone 12 according to the instructions or data and display the operation as images by the display panel 24, such as a liquid crystal display (LCD). The wireless communication module 18 can receive radio signals from a wireless communication network 40, such as radio signals from a base station of the wireless communication network 40 to the mobile phone 12. The wireless communication module 18 also can transmit radio signals to a base station for exchanging radio signals with the wireless communication network 40. The speaker 26 transforms electrical signals to sound waves and plays the sound waves. The microphone 28 is used to receive sound waves and transform the sound waves to electrical signals. In another aspect, the headset 14 comprises a wireless headset module 30, a speaker 32, and a microphone 34. The wireless headset module 30 in the headset 14 corresponds to the wireless headset module 20 in the mobile phone 12. The wireless headset modules 30 and 20 can exchange radio signals with each other. The speaker 32 of the headset 14 transforms the electrical signals from the wireless headset module 30 to sound waves and plays the sound waves. The microphone 34 transforms sound waves to electrical signals and transmits the electrical signals to the wireless headset module 30.

Below is the description of how a user uses the mobile phone 12 to perform a wireless communication in the mobile phone system 10. In the wireless communication network 40, a remote mobile phone transmits radio speech signals 36A through the base station to the mobile phone 12, and the radio speech signals 36A are received by the wireless communication module 18 and are demodulated and decoded to electrical speech signals 36B. The electrical speech signals 36B are transmitted through the control circuit 16 to the speaker 26 by the way of speech signals 36C, and the speaker 26 transforms the speech signals 36C to sound waves and plays the sound wave so that the user of the mobile phone 12 can hear the voice from the remote mobile phone. On the other hand, the voice (sound waves) of the user of the mobile phone system 10 can be transformed to electrical audio signals 38A by the microphone 28 of the mobile phone 12 and then be formed as audio signals 38B through the transmission of the control circuit 16. Then the audio signals 38B are coded and modulated by the wireless communication module 18 to become radio communication signals 38C and are transmitted to the wireless communication network 40, such as through a base station to a remote mobile phone. Therefore a user can use the mobile phone 12 to perform a speech communication with another user of the remote mobile phone through the wireless communication network 40.

Besides the mobile phone 12, the user can use the headset 14 to perform a speech communication of the wireless communication network. The user may operate the control circuit 16 to switch the speech communication to the headset 14. When using the headset 14 to perform the speech communication, the wireless communication module 18 receives radio speech signals 36A. Then the radio speech signals 36A are transformed to electrical speech signals 36B, transmitted to the wireless headset module 20, and coded and modulated to become radio headset signals 36D by the wireless headset module 20. The radio headset signals 36D are transmitted from the wireless headset module 20 to the wireless headset module 30 of the headset 14. After receiving the radio headset signals 36D, the wireless headset module 30 decodes and demodulates the radio headset signals 36D to transform the radio headset signals 36D to electrical headset signals 36E. Then the electrical headset signals 36E are transmitted to the speaker 32, transformed to sound waves by the speaker 32, and played by the speaker 32. The sound waves of the user can be transformed to electrical audio signals 38D by the microphone 34 of the headset 14. The electrical audio signals 38D are then coded and modulated to radio audio signals 38E by the wireless headset module 30 such that the radio audio signals 38E are transmitted to the mobile phone 12. After receiving the radio audio signals 38E, the wireless headset module 20 decodes and demodulates the radio audio signals 38E, and then the radio audio signals 38E are transformed to audio signals 38B by the control circuit 16 and transmitted to the wireless communication module 18 of the mobile phone 12. Then the wireless communication module 18 codes and modulates the audio signals 38B to transform the audio signals 38B to radio communication signals 38C, and transmits the radio communication signals 38C to the wireless communication network 40. In other words, though the wireless communication module 18 is the main apparatus for accessing the wireless communication network 40, the user can select to use the speech communication interface provided by the speaker 26 and the microphone 28 of the mobile phone 12 or the speech communication interface provided by the speaker 32 and the microphone 34 of the headset 14 to make use of the wireless communication module 18 for performing a wireless communication, such as answering or replying a phone call. The wireless communication modules 20 and 30 of the mobile phone 12 and the headset 14 are used to form a radio logic connection between the mobile phone 12 and the headset 14 for connecting the mobile phone 12 and the headset 14 without any wires.

In general, the radio frequency band of the wireless communication module 18 for accessing the wireless communication network 40 is different from the radio frequency band of the wireless communication modules 20 and 30. In addition, the mechanism of coding/decoding and modulation/demodulation of the wireless communication module 18 is different from that of the wireless communication modules 20 and 30, too. In current technology, the frequency band used when the wireless communication module 18 accessing the information of the wireless communication network 40 is mainly at 900 MHz (1 MHz=10⁶ Hz), 1800 MHz, or 1900 MHz. And the CDMA(code division multiple access) is adapted as the connection of the wireless communication network. For the reason of exchanging radio information with a base station with long distance, the wireless communication module 18 usually has to transmit signals with high power. Contrary to the connection between a mobile phone and a base station, the radio connection between the wireless headset module 20 and the wireless headset module 30 adapts the ISM (industrial, scientific, and medical) band, which is at about 2.5 GHz (1 GHz=1000 MHz), and the standard of the radio connection can adapt the bluetooth standard. Although the radio signals with high frequency adapted by the wireless headset modules 20 and 30 decay much as the distance changes, the primary function of the radio connection is only to substitute for a real connection wire. Therefore only an appropriate effective frequency range is needed. In addition, the radio transmitting power between the wireless headset modules 20 and 30 is not required to be too high. The effective area of the radio connection between a mobile and a headset is about 10 m in current technology. In other words, a user may only wear the light and convenient headset 14 to perform a wireless speech communication when the user is in the effective area of the radio connection of the wireless headset modules 20 and 30. Thus the latent danger caused by using the mobile phone 12, such as the distraction of the user, may be avoided, and the opportunity of the user being exposed to the higher transmitting power of the wireless communication module 18 may be reduced.

In the above description, the wireless headset 14 can solve the limitation between the user and the mobile phone 12 so that the user does not need to carry the mobile phone 12 with him and still can perform a wireless speech communication. However, a new problem coming with the wireless headset 14 is that the user may forget where the mobile phone 12 is. Since the user could only wear the headset 14 to make speech communications and go anywhere in the effective area of the radio connection, the user may put the mobile phone 12 somewhere casually and later forget the location. For example, the user could put the mobile phone 12 in a location in his office and move around in a certain area of his office with the headset 14 to keep performing the wireless speech communication. When the user needs to go to a far distance place, such as leaving his office, he must bring the mobile phone 12 with him, and he may forget the location where the mobile phone 12 is at that time. Therefore the user needs to search for the mobile phone 12 in the area of his office, and it is very inconvenient for the user.

### SUMMARY OF INVENTION

It is therefore a primary objective of the claimed invention to provide a wireless headset of a mobile phone system, which is capable of triggering a mobile phone to signal a location of the mobile phone to solve the above-mentioned problem. Moreover, a method of using the provided mobile phone system and an operating method of the provided mobile phone system also are provided.

According to the prior art, the wireless headset may provide the user a convenient interface for the speech communication so that the user does not have to carry the mobile phone with him, however the user is more likely to forget the location of the mobile phone, and that will cost much time for the user to look for the mobile phone.

According to the claimed invention, a control interface is set on the wireless headset. Therefore the user can operate the control interface to make the wireless headset transmit a radio signal to trigger the mobile phone to produce a predetermined signal (for example, sound, light, or vibration) such that the user can easily find the mobile phone.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a function block diagram of a mobile phone and a headset of a mobile phone system according prior art.

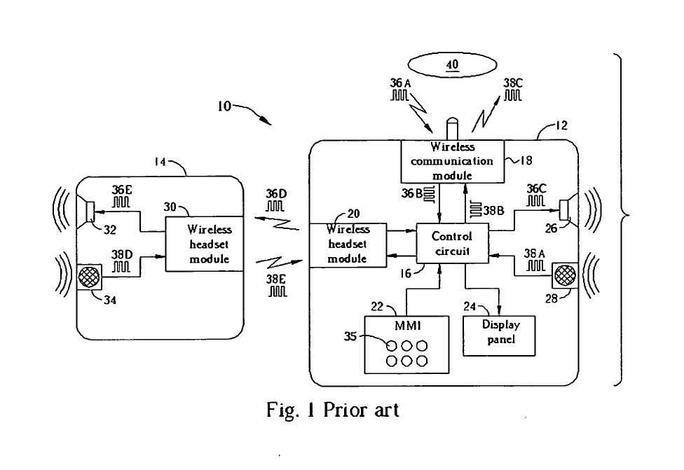

FIG. 2 is a function block diagram of a mobile phone and a headset of a mobile phone system according to the present invention.

FIG. 3 is an outward diagram of the mobile phone system shown in FIG. 2.

### DETAILED DESCRIPTION

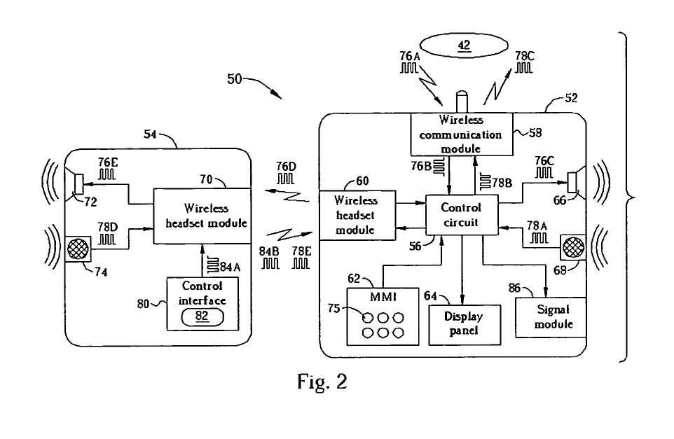

Please refer to FIG. 2. FIG. 2 is a function block diagram of a mobile phone 52 and a wireless headset 54 of a mobile phone system 54 according to the present invention. The mobile phone 52 comprises a control circuit 56, a wireless communication module 58, a wireless headset module 60, a speaker 66, a microphone 68, a signal module 86, a display panel 64, and an MMI 62. The wireless headset 54 comprises a wireless headset module 70, a speaker 72, a microphone 74, and a control interface 80. The MMI 62 is electrically connected to the control circuit 56, wherein the MMI 62 may comprise a plurality of buttons 75 for accepting the input from the operation of the a user to produce corresponding electrical signals. According to the corresponding electrical signals produced by the MMI 62, the control circuit 56 can control the operation of the mobile phone 52 and show the operation as figures on the display panel 64 (for example, an LCD panel). The wireless communication module 58 is used for transmitting and receiving radio signals to access a wireless communication network 42. The speaker 66 is used for transforming electrical signals to sound waves and playing the sound waves. The microphone 68 is used for transforming the sound waves to electrical signals. In the wireless headset 54, the wireless headset module 70 cooperates with the wireless headset module 60 of the mobile phone 52 to build up a radio logic connection. The speaker 72 can transform the electrical signals from the wireless headset module 70 to sound waves, and the microphone 74 can transform the sound waves to electrical signals and transmit the electrical signals to the wireless headset module 70. In addition, the present invention wireless headset 54 further comprises a control interface 80. The control interface 80 is electrically connected to the wireless headset module 70. The wireless headset 54 may have a button 82. When the user pushes the button 82, the control interface 80 will transmit a predetermined control signal 84A to the wireless headset module 70.

Below is the description of the operation for a user using the mobile phone 52 to perform a wireless speech communication in the mobile phone system 50. In the wireless communication network 42, the radio speech signals 76A transmitted from another remote mobile phone through a base station are received by the wireless communication module 58 in the mobile phone 52. Then the radio speech signals 76A are decoded and demodulated to electrical speech signals 76B, and the electrical speech signals 76B are transmitted through the control circuit 56 to form speech signals 76C. The speaker 66 transforms the speech signals 76C to sound waves and plays the sound waves. In another aspect, the sound waves of the user are transformed to electrical audio signals 78A by the microphone 68. The electrical audio signals 78A are transformed to audio signals 78B by the control circuit 56 and transmitted to the wireless communication module 58. The wireless communication module 58 then codes and modulates the audio signals 78B to transform the audio signals 78B to radio communication signals 78C, and the wireless communication module 58 transmits the radio communication signals 78C to the wireless communication network 42, such as to transmit the signals from a base station to a remote mobile phone. Therefore the user can directly use the speaker 66 and the microphone 68 of the mobile phone 52 as the speech communication interface to access the wireless communication network 42 through the wireless communication module 58 for performing the wireless communication.

In another aspect, the user can switch to use the wireless headset 54 as the speech communication interface. In this situation, the radio speech signals 76A are received by the wireless communication module 58, and the corresponding speech signals 76B are produced and transmitted to the wireless headset module 60 by the control circuit 56. Then the wireless headset module 60 codes and modulates the speech signals 76B to transform the speech signals 76B to radio headset signals 76D. The radio headset signals 76D are transmitted to the wireless headset 54 through the radio connection between the wireless headset modules 60 and 70. After the wireless headset module 70 of the wireless headset 54 receives the headset signals 76D, the wireless headset module 70 decodes and demodulates the headset signals 76D to transform the headset signals 76D to electrical headset signals 76E. Then the speaker 72 transforms the headset signals 76D to sound waves and plays the sound waves. The sound waves of the user are received by the microphone 74 and transmitted to the wireless headset module 70 as electrical audio signals 78D. The electrical audio signals 78D are then coded and modulated by the wireless headset module 70 and transformed to radio audio signals 78E. The radio audio signals 78E are transmitted to the wireless headset module 60 through the radio connection between the wireless headset modules 70 and 60.After that, the wireless headset module 60 decodes and demodulates the radio audio signals 78E to electrical signals. The electrical signals become audio signals 78B through the switch control of the control circuit 56. Then the wireless communication module 58 codes and modulates the audio signals 78B to radio communication signals 78C and transmits the radio communication signals 78C to the wireless communication network 42. Therefore the user may use the speaker 72 and the microphone 74 of the wireless headset 54 as a speech communication interface by using the radio connection between the wireless headset modules 60, 70 to access the wireless communication network 42 by the wireless communication module 58, such answering or responding to a phone call of the wireless communication network 42.

In the preferred embodiment according to the present invention, the radio connection between the wireless headset modules 60 and 70 is set under the standard of bluetooth with a high frequency of the ISM frequency band so that the user can perform a speech communication by the wireless headset 54 in a certain area without carrying the mobile phone 52. In contrast to the prior art in which the user may lose the location of a mobile phone, the wireless headset 54 of the present invention comprises the control interface 80 to cooperate with the signal module 86 for signaling the location of the mobile phone 52. The method of the operation according to the present is described below. When the user wants to find the mobile phone 52, he could push the button 82 on the control interface 80 of the wireless headset 54 and the control interface 80 transmits a corresponding control signal 84A to the wireless headset module 70. The wireless headset module 70 receives the control signal 84A, and then the control signal 84A is coded and modulated by the wireless headset module 70 to form a radio control signal 84B. The radio control signal 84B is transmitted to the mobile phone 52 through the radio connection between the wireless headset modules 60 and 70, and is received by the wireless headset module 60 of the mobile phone 52. After receiving the radio control signal 84A, the wireless headset module 60 decodes and demodulates the radio control signal 84A to an electrical control signal. Then the electrical control signal is transmitted to the control circuit 56, and the control circuit 56 triggers the signal module 86 to make a predetermined sound according to the electrical control signal to notify the user the location of the mobile phone 52. Therefore the user could find the mobile phone 52 according to the sound produced by the signal module 86.

According to the present invention, the functionality of the signal module 86 can be realized by the speaker 66, which is an existed apparatus of the mobile phone 86, or the signal module 86 can be realized by another speaker. In addition, a current mobile phone may have a vibrator to produce a vibration for showing an incoming call, therefore the signal module 86 can comprise a vibrator to signal the location of the mobile phone 52. Similarly, the functionality of the signal module 86 can also be realized by the vibrator already in a prior-art mobile phone. Furthermore, the display panel may have different colors of light or different kind of flash in a prior-art mobile phone, so the signal module 86 can use the different colors of light or flash by the display panel 64 to signal the location of the mobile phone 52. In other words, after the user operates the control interface 80 to transmit a control signal 84A to the control circuit 56 through the radio connection between the wireless headset modules 60 and 70, the control circuit 56 can not only trigger the signal module 86 to vibrate the mobile phone 52 and produce a sound but also trigger the display panel 64 to show a predetermined mode, such as a various colored flash to signal the user where the mobile phone 52 is. The signal module 86 can further comprise an instruction light for shining a predetermined mode of light to direct the location of the mobile phone 52. The sound, vibration, or light for directing the location of the mobile phone 52 can be set by the manufacturer or by the user to be saved in a non-volatile memory of the control circuit 56. For example, the user can record a special voice or music in the mobile phone 52 for being the predetermined sound to signal the location of the mobile phone 52 when he pushes the button 82 of the control interface 80. In addition, the wireless communication module 58 and the wireless headset module 60 may be combined if the wireless communication module 58 can support the functionality of the wireless communication module 60.

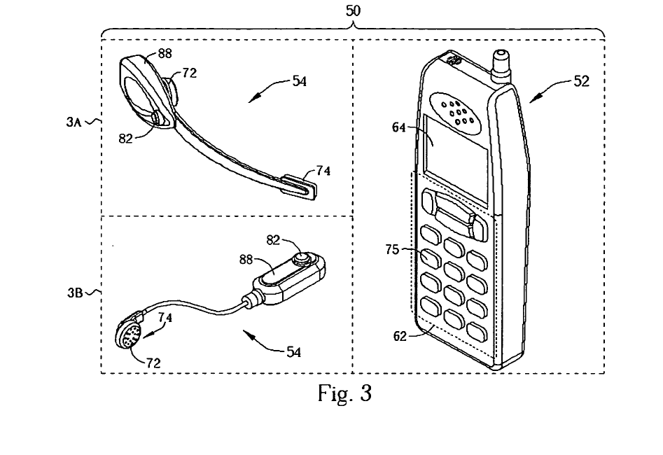

Please refer to FIG. 3, as well as FIG. 2. FIG. 3 is an outward diagram of the mobile phone system 50 according to the present invention. The mobile phone 52 of the mobile phone system 50 comprises the display panel 64 and a plurality of buttons 75 to complete the MMI 62 for performing the functionality of accepting the input from the user. FIGS. 3A and 3B show two kinds of probable outward appearances of the headsets 54. As shown in FIGS. 3A and 3B, the wireless headset module 70 and control interface 80 of the wireless headset 54 can be set in the primary body 88, and the speaker 72 and the microphone 74 are used together to be an interface for the user to perform speech communication. When the user pushes the button 82, the mobile phone 52 is triggered to signal its location through the radio connection between the wireless headset 54 and the mobile phone 52.

In conclusion, although the wireless headset can provide a wireless and convenient interface of the speech communication of the wireless communication network so that the user does not have to carry the mobile phone, the prior-art mobile phone and headset may produce a problem in that the user can easily forget the location of the mobile phone. The mobile phone system according to the present invention can completely solve this problem. The wireless headset of the present invention mobile phone system further comprises a control interface so that the user could use the wireless headset to contact the mobile phone and make the mobile phone produce a predetermined sound, vibration, or flash by the control interface of the wireless headset to instruct the location of the mobile phone. Therefore the user can easily find the mobile phone and does not have to pay attention to the location of the mobile phone.

Accordingly, the operation of the mobile phone system can be summarized as the following two methods: a method of using it, from the viewpoint of the user, and an operating method of it, from the viewpoint of the system.

The method for using a mobile phone system, which has at least a mobile phone and a headset, has at least the following main step: trigger the mobile phone of the mobile phone system by operating the wireless headset to signal a location of the mobile phone. Hence, the triggered mobile phone produces a predetermined signal when the mobile phone is not receiving a phone call. Moreover, the predetermined signal is chosen from the group consisting of the following: sound, light, and vibration.

The operating method of a mobile phone system, which has at least a mobile phone and a headset, has at least the following main steps: (a) the headset transmitting a radio signal; (b) the mobile phone receiving the radio signal; and (c) the mobile phone producing a predetermined signal when the mobile phone is not receiving a phone call. Similarly, the predetermined signal is chosen from the group consisting of sound, light, and vibration.

Those skilled in the art will readily observe that numerous modifications and alterations of the device may be made while retaining the teachings of the invention. Accordingly, the above disclosure should be construed as limited only by the metes and bounds of the appended claims.

1 A mobile phone system comprising:
a mobile phone comprising:
a wireless communication module for receiving a radio speech signal;
a first wireless headset module for transmitting a radio headset signal according to the radio speech signal received by the wireless communication module and for receiving a radio control signal; and
a signal module for signaling a location of the mobile phone according to the radio control signal received by the first wireless headset module; and
a headset comprising:
a control interface for producing the radio control signal corresponding to an operation of a user;
a second wireless headset module electrically connected the control interface, wherein the second wireless headset module is capable of transmitting the radio control signal and receiving the radio headset signal; and
a speaker electrically connected to the second wireless headset module for transforming the radio headset signal from the second wireless headset module to a sound wave and playing the sound wave.

2 The mobile phone system of claim 1, wherein the location of the mobile phone is signaled by generating a predetermined signal selected from the group consisting of sound, light and vibration.

3 The mobile phone system of claim 1, wherein the headset further comprises a microphone for receiving a sound wave and transforming the sound wave to a radio audio signal, and the second wireless headset is further capable of transmitting the radio audio signal.

4 The mobile phone system of claim 3, wherein the first wireless headset is further capable of receiving the radio audio signal, and the wireless communication module is further capable of transmitting a radio communication signal corresponding to the radio audio signal received by the first wireless headset module.

5 The mobile phone system of claim 1, wherein the mobile phone further comprises a speaker, and the speaker of the mobile phone is capable of transmitting a sound wave corresponding to the speech signal received by the wireless communication module.

6 The mobile phone system of claim 1, wherein the signal module is further capable of transmitting a sound wave corresponding to the speech signal received by the wireless communication module.

7 The mobile phone system of claim 1, wherein the mobile phone further comprises a microphone for receiving a sound wave and transforming the sound wave to a radio audio signal, and the wireless communication module is further capable of transmitting the radio audio signal.

8 A method for using a mobile phone system which has at least a mobile phone and a headset, the method comprising:
triggering the mobile phone of the mobile phone system by operating the headset of the mobile phone system to signal a location of the mobile phone, wherein the triggered mobile phone produces a predetermined signal when the mobile phone is not receiving a phone call.

9 The method of claim 8, wherein the predetermined signal is selected from the group consisting of sound, light, and vibration.

10 The method of claim 8, wherein the mobile phone is capable of receiving a control signal from the headset to trigger the mobile phone to produce the predetermined signal, and the headset comprises a control interface for producing the control signal corresponding to an operation of a user, the method further comprising:
operating the control interface so that the headset is capable of transmitting the control signal to the mobile phone to trigger the mobile phone to produce the predetermined signal for signaling the location of the mobile phone when the mobile phone is not receiving a phone call.

11 The method of claim 10, wherein the control signal transmitted from the headset is a radio signal, and the mobile phone is capable of receiving the radio signal.

12 An operating method of a mobile phone system which has at least a mobile phone and a headset, the method comprising:
the headset transmitting a radio signal;
the mobile phone receiving the radio signal and signaling the location of the mobile phone accordingly.

13 The method of claim 12, wherein the location of the mobile phone is signaled by sound, light, or vibration.

14 The method of claim 12, wherein the mobile phone is capable of receiving a control signal from the headset to trigger the mobile phone to signal the location of the mobile phone and the headset comprises a control interface for producing the control signal corresponding to an operation of a user, the method further comprising:
operating the control interface so that the headset is capable of transmitting the control signal to the mobile phone to trigger the mobile phone to signal the location of the mobile phone when the mobile phone is not receiving a phone call.

15 The method of claim 14, wherein the control signal transmitted from the headset is a radio signal, and the mobile phone is capable of receiving the radio signal.
